(19) United States
(12) Patent Application Publication
(10) Pub. No.: US 2024/0116309 A1
(43) Pub. Date: Apr. 11, 2024

(54) DECORATIVE APPLIQUE WITH POLYMERIC OVER-COATING AND METHOD OF APPLYING SAME

(71) Applicant: SUPERIOR INDUSTRIES INTERNATIONAL, INC., SOUTHFIELD, MI (US)

(72) Inventors: CHRISTOPHER ALLEN WATTS, Milford, MI (US); HENRY CLAY CHENAULT, III, Fayetteville, AR (US)

(73) Assignee: SUPERIOR INDUSTRIES INTERNATIONAL INC., SOUTHFIELD, MI (US)

(21) Appl. No.: 17/767,881

(22) PCT Filed: Aug. 27, 2020
(86) PCT No.: PCT/US2020/048197

§ 371 Date: Apr. 9, 2022

Related U.S. Application Data
(60) Provisional application No. 62/892,208, filed on Aug. 27, 2019.

(51) Int. Cl. B60B 7/00; B60B 27/00

(52) U.S. Cl. CPC B60B 7/0053; B60B 7/0046; B60B 27/0047; B05D 5/066; B60B 2310/656

(57) ABSTRACT

A vehicle wheel is defined by a substrate including a face and a rim portion. The face defines a plurality of spokes extending radially outwardly between a central portion of the face and the rim portion and defining a mating portion. An applique is affixed to the wheel at the mating portion. A polymer over-coating that is substantially transparent extends over the applique and the wheel substrate defining a continuous polymer surface over the applique and the wheel substrate.

### PRIOR APPLICATIONS

The present application claims priority to International Patent Application No. PCT/US2020/048197 filed Aug. 27, 2020 which claims priority to U.S. Provisional Patent Application No. 62/892,208 filed on Aug. 27, 2019, the contents of which are included herein by reference.

### TECHNICAL FIELD

The present invention relates generally toward application of decorative features to a vehicle component. More specifically, the present invention relates toward a vehicle wheel with a decorative applique and a method of manufacturing same.

### BACKGROUND

Ever increasing consumer desires with regard to customized passenger vehicles have caused vehicle manufacturers and their suppliers to identify unique distinguishing features. Vehicle wheels have not been exempted from these consumer desires. In addition, it is becoming increasingly desirable to include unique brand identifiers on, for example, vehicle wheels. Therefore, wheel manufacturers have been seeking different manufacturing techniques that provide distinguishing features including machining unique features into the wheel alloy, unique coating technologies and the addition of metallic layers.

Unique performance requirements of vehicle wheels have prevented additional distinguishing features, such as adhering appliques, in the form of brand identifiers and the like. Application of these items has not been attempted due to durability deficiencies when subject the rigors of, for example, dirt and gravel roads, road salt, and other environmental contaminants. However, there is a market desire to include distinguishing features on vehicle wheels that, to date, could only be provided by way of an applique. Therefore, there is a significant need to develop a process and technique for applying distinguishing features to a wheel that would enable application of unique brand identifiers to a wheel while still providing necessary durability and performance.

### SUMMARY

A vehicle wheel is defined by a wheel substrate including a face and a rim portion. The face defines a plurality of spokes extending radially outwardly between a central portion defined by the face and the rim portion. An applique including a decorative feature that is distinguishable from the wheel is affixed to a mating portion of the wheel. A polymer over-coating is applied over the applique and the wheel that is substantially transparent covering the applique and the wheel defining a continuous polymer surface over the applique and the wheel substrate.

Significant efforts have been expended to develop polymeric coatings for wheels that are capable of withstanding environmental rigors of a wide range of road surfaces and other environmental factors. However, appliques and labels have not been capable of providing requisite durability when applied over these coatings. This problem is overcome by the invention of the present application. The inventive process of applying durable polymer coatings over the applique and the wheel after the applique has been adhered to a wheel provides the benefit of providing performance characteristics of the polymer coating while protecting the applique from known environmental contaminants. In addition, unique tinting, coloring and pigmenting techniques applied to the polymeric over-coating can provide additional unique appearance characteristics. For example, presenting a continuous polymer surface offers esthetic characteristic previously not available to vehicle wheels. The continuous polymeric over-coating presents a same gloss level over both the applique and the wheel surface giving the appearance of the applique being part of the wheel substrate.

### BRIEF DESCRIPTION OF THE DRAWINGS

Other advantages of the present invention will be readily appreciated, as the same becomes better understood by reference to the following detailed description when considered in connection with the accompanying drawings, wherein:

FIG. 1 shows a partial perspective view of a wheel including a decorative applique;

FIG. 2 shows cross-section of a first embodiment of a wheel of the present invention;

FIG. 3 shows a cross-section of a second embodiment of a wheel of the present invention;

FIG. 4 shows a cross-section of a third embodiment of a wheel of the present invention;

FIG. 5 shows a cross-section of a fourth embodiment of a wheel of the present invention;

FIG. 6 shows a cross-section of a fifth embodiment of a wheel of the present invention;

FIG. 7 shows a cross-section of a sixth embodiment of a wheel of the present invention;

FIG. 8 shows a cross-section of a seventh embodiment of a wheel of the present invention;

FIG. 9 shows a cross-section of an eighth embodiment of a wheel of the present invention;

FIG. 10 shows a partial perspective view of a wheel including an alternative applique providing a textured appearance;

FIG. 11 shows a partial perspective view of an applique disposed in a recessed portion of a face of the wheel;

FIG. 12 shows a cross-section through line 12-12 of FIG. 11; and

FIG. 13 shows a flow chart of a process for manufacturing a wheel including the inventive decorative applique.

### DETAILED DESCRIPTION

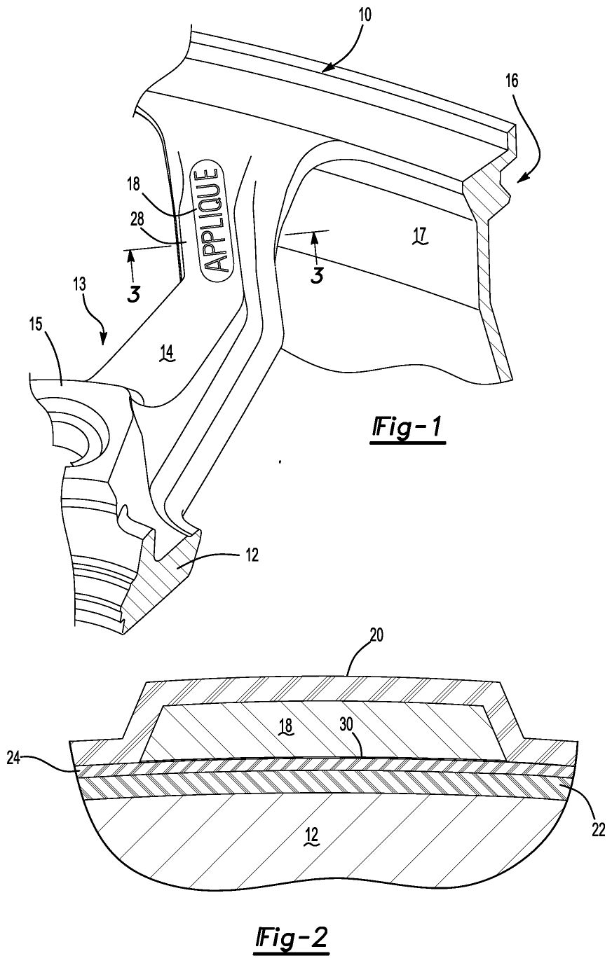

Referring to FIG. 1, a partial perspective view of a wheel of the present invention is generally shown at 10. The wheel 10 includes a formed wheel substrate 12 defining a face 13 and a rim portion 16. Spokes 14 extend between a central portion 15 of the face 13 and a bead 17 defined by the rim portion 16 that defines a periphery of the wheel 10. A decorative applique 18 is adhered to one of the spokes 14 presenting, in this embodiment, the brand identifier shown “APPLIQUE”. It should be understood that the brand identifier shown in FIG. 1 is merely exemplary and may be replace by alternative identifiers or slogans, including but not limited to third party brands, wheel brands, customer brands, etc. In addition, the applique 18 may present a texture or patterns to the wheel that previously required complex tooling or machining to form into substrate 12 as will be explained further herein below.

By way of example, the applique 18 is contemplated take many forms. In one embodiment, the applique 18 is a two dimensional decal presenting brand names, patterns, slogans, and any number of alternatives and combinations. In an alternative embodiment, the applique 18 is a three dimensional component that is painted, coated, chromed, or decorated in any manner that may be complementary to the wheel 10 or message being conveyed. The applique 18 is contemplated to include lettering or graphical features extending upwardly from a base for providing additional distinguishing characteristics. Additionally, the applique 18 is contemplated to include coloring that blends with a wheel 10 color or coloring that contrasts with the wheel 10 coloring. Additional distinguishing features are exhibited when the applique 18 is affixed to the wheel substrate 12 that presents an alloy background appearance to the applique 18 that will also be explained further hereinbelow.

Referring now to FIG. 2, a first embodiment shows the applique 18 affixed to the wheel 10. A polymeric over-coating 20 is applied over the wheel 10 and the applique 18 presenting a continuous polymeric surface extending over both the wheel 10 and the applique 18 as disclosed hereinabove. The polymeric over-coating 20, in one embodiment is a clear coating presenting a consistent or same gloss level to the applique 18 and the wheel 10. In an alternative embodiment, the polymeric over-coating 20 is lightly pigmented or tinted uniformly providing depth or modified appearance to the wheel 10 and the applique 18. In a still further alternative embodiment, the polymeric over-coating 20 includes opalescent pigmentation providing an even further color shifting esthetic enhancement to the applique 18. Further, the polymeric over-coating includes any of a powder coating, an urethane, or any polymeric coating capable of providing desirable durability to the applique 18 (and the wheel 10). The applique 18 is heat resistant to at least the temperature required to cure the polymeric over-coating 20 in an industrial paint bake oven. The polymeric over-coating 20 includes ultraviolet absorbers to deter breakdown of the polymer chains and provide further durability to the applique 18 by preventing ultraviolet degradation.

It should be understood that alternative coating and curing techniques may be used to apply the clear coat or polymeric over-coat 20 over the applique 18. As set forth above, one embodiment, the polymeric over-coat 18 is a powder coating. Alternatively, the clear coat 20 can be a one or two component urethane. After applying the polymeric over-coat 20 over the applique 18 and wheel 10, the wheel 10 is subject to a curing step in a bake oven or the like. Therefore, the applique 18 is capable of withstanding curing temperatures of the polymeric over-coat 20 that could exceed 280° F. Alternatively, the curing temperature of the polymeric over-coat 20 is adjusted to accommodate lower thermal limits of the applique 18.

A primer or base polymeric coating 22 is applied to the wheel 10 prior to adhering the applique 18 to the wheel 10. The base polymeric coating 22 provides durability to the wheel by improving adhesion of the polymeric over-coatings 20 and inhibits corrosion. An intermediate polymeric coating 24 providing a pigmented base color is applied over the primer or base polymeric coating 22. Therefore, in this embodiment, the applique 18 is adhered to the intermediate polymeric coating 24.

In a further alternative embodiment, the polymeric over-coat 20 may be cured by way of exposure to infrared (IR) light to accommodate lower thermal limits of the applique 18. IR curing techniques are sometimes used for “spot repairs” in automotive assembly plants. However, regular production IR curing has not previously been used for automotive components, such as, for example, vehicle wheels. IR curing provides the potential to apply the polymeric over-coat 20 over the entire wheel surface, or only locally over the applique 18 while “feathering” the IR cured coating into previously applied and cured over-coat 20 or the intermediate polymeric coating 24 onto which the applique 18 is placed.

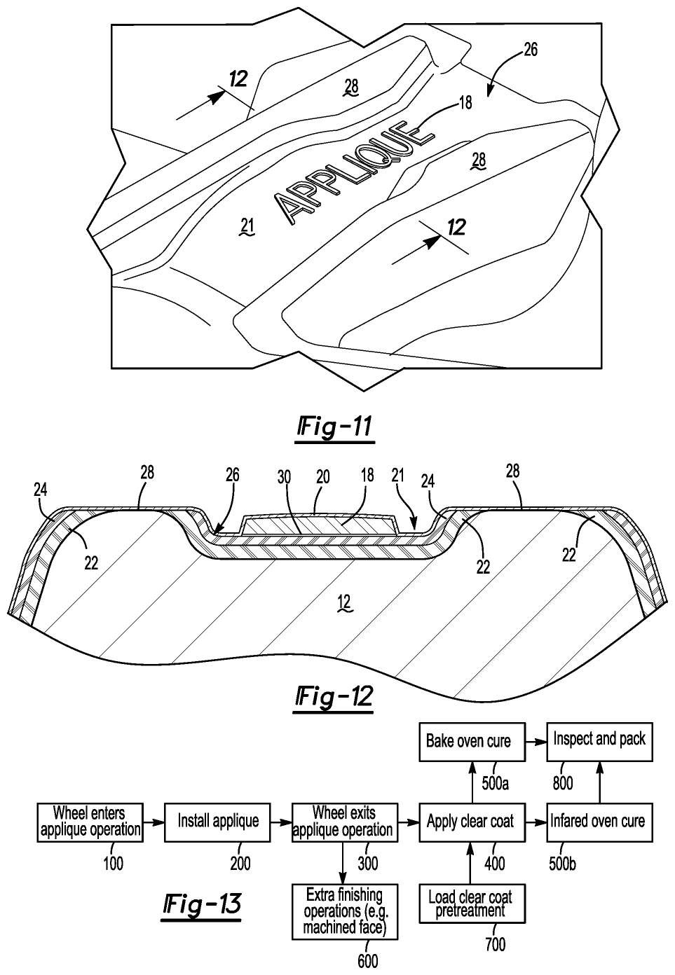

In a further embodiment, the wheel 10 may require additional cleaning and conversion after the applique 18 has been applied. In one embodiment, the applique 18 is applied to a mating portion 21 on a recessed surface 26 (as shown in FIG. 11) that is spaced below an upper surface 28. The upper surface 28 is subsequently turned, machined, or milled to expose or reconfigure the face 13. In this embodiment, after turning, machining or milling, the wheel 10 is subsequently cleaned and provided a conversion coating in a known manner. Alternatively, the wheel 10 may be subject to a localized dry plasma conversion as disclosed in co-pending U.S. patent application Ser. Nos. 15/524,075 and 16/256,550, the contents of which are incorporated herein by reference. In either embodiment, the applique 18 is configured to withstand the additional processing without discernable degradation of appearance. It is contemplated by the inventors that subjecting the applique 18 to a conversion coating will also enhance adhesion of the polymeric over-coating 20 to the applique 18. Following cleaning and conversion, the polymeric over-coating 20, or equivalent is applied over the applique 18 as is described herein.

The applique 18, in one embodiment is a decal that is adhered to the wheel 10 with an adhesive 30. In another embodiment, the applique 18 is plastic or composite presenting a three dimensional structure providing an appearance of depth to the applique 18 that also may be affixed to the wheel 10 with the adhesive 30. A snap or locating pin (not shown) may be included on a backside of the applique 18 to provide additional retention or assist locating the applique 18, if necessary. Alternatively, a template may be used to locate the applique, or backing paper or cover paper may be configured to locate the applique 18 and is subsequently removed after application. The adhesive 30 is selected for optimal adhesion to the one of the wheel substrate 12 or the intermediate polymeric coating 24, whichever is selected for desired appearance.

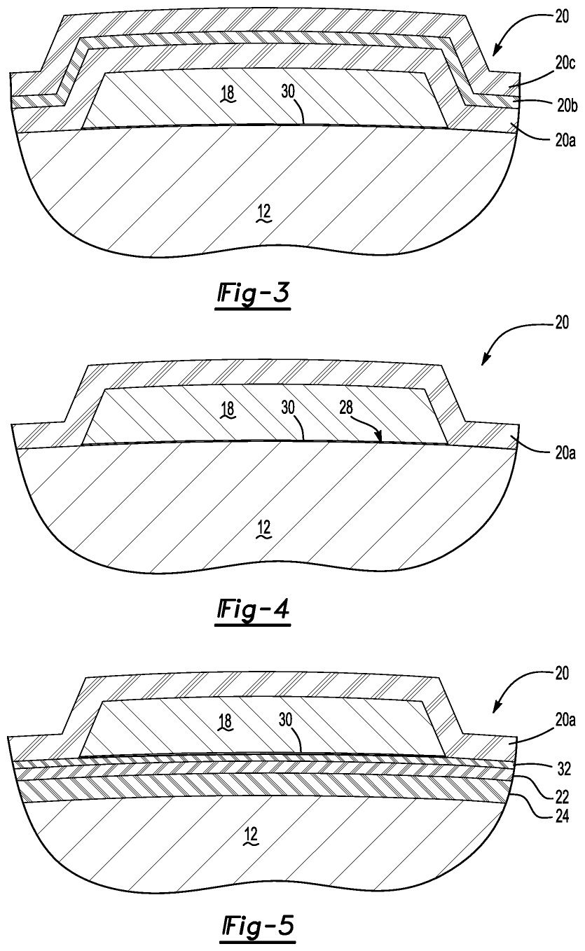

FIG. 3 shows an alternative embodiment where the applique 18 is adhered to the substrate 12 of the wheel 10 as is explained hereinabove. Prior to adhering the applique 18 to the wheel 10, the wheel 10 surface is cleaned and treated with at least one of a dry conversion coating or conventional conversion coating to improve adhesion of the applique 18 and of the polymeric over-coating 20 upon application. In this embodiment, multiple polymeric over-coatings may be implemented. As in the first embodiment, a first polymeric-over-coating 20a is applied over both the applique 18 and the wheel 10 presenting a continuous polymeric surface. A second polymeric over-coating 20b and a third polymeric over-coating 20c are sequentially applied. Each of the polymeric coatings 20a, 20b, 20c may be a clear, transparent coating or include differing levels of pigmentation, dye or tint to achieve different aesthetics or depth to the face 13 of the wheel 10 and to the applique 18. Further, only two layers of polymeric over-coating 20a, 20b may be applied over the applique 18 and the wheel 10 to provide differing levels of environmental protection, durability and aesthetics.

FIG. 4 shows a still further alternative embodiment where the applique 18 is adhered to the substrate 12 of the wheel 10 and only the first polymeric over-coating 20a is applied. The first polymeric coating 20a again presents a continuous polymeric surface of the applique 18 and the wheel 10. The wheel 10 in this embodiment, and in other embodiments where the applique 18 is adhered to the substrate 12, a previously applied polymeric coating may be mechanically removed prior to adhering the applique 18. The machined surface, in this embodiment the upper surface 28 of the face 13 (FIG. 1), is subject to cleaning and either dry conversion or conventional conversion coatings to improve adhesion of the applique 10 and the first polymeric coating.

FIG. 5 shows a further embodiment of the invention of the present application that includes a PVD metalized layer 32. As is known to those of skill in the art, PVD is a process for physical vapor deposition of metals and metal alloys on a wheel or polymeric coating of a wheel providing a metallic appearance. Therefore, this embodiment includes the applique 18 being adhered directly to the PVD metalized layer 32 by way of an adhesive 30. As such, it may be desirable to modify the adhesive 30 used to adhered the applique 18 to the PVD metalized layer 32 from that which is used to adhere the applique 18 to a polymeric coating. Prior to applying the PVD metalized layer 32, the base polymeric coating 22 is applied to the substrate 12 of the wheel 10. The intermediate polymeric coating 24 is applied over the base polymeric coating 22 prior to the application of the PVD metalized layer 32 to achieved desired adhesion of the PVD metalized layer to the wheel 10. Therefore, the base polymeric coating 22, the intermediate polymeric coating 24 and the PVD metalized layer 32 are applied in sequential order between the applique 18 and the wheel substrate 12.

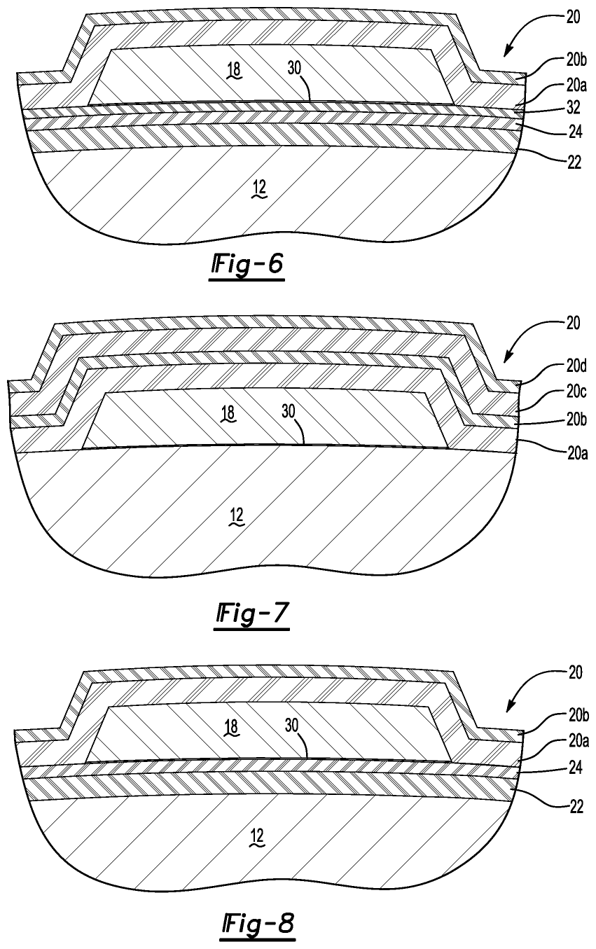

FIG. 6 shows a still further embodiment that includes a modified first polymeric over-coat 20a is applied over the wheel 10 and a second polymeric over-coat 20b is applied over the first polymeric over-coat 20a. Therefore embodiment shown in FIG. 6 is a modification of the embodiment shown in FIG. 5 that includes two polymeric over-coats 20a, 20b to achieve additional distinguishing visual characteristics. The applique 18 is adhered via the adhesive 30 to the PVD metalized layer 32 that has been deposited over the intermediate polymeric coating 24 and the base polymeric coating 22. The second polymeric over coat 20b includes colorization by way of pigmentation or tint while maintaining translucence or transparency so that the applique 18 is visible. Alternatively, the gloss level of the second polymeric over coat 20b is modified to a mid, low level, or matted gloss level to provide even different aesthetics. In this embodiment, the first polymeric overcoat 20a includes no additional colorization and is substantially clear to illuminate the applique 18.

FIG. 7 shows a further embodiment including the third polymeric over-coat 20c and a fourth polymeric over-coat 20d that are sequentially applied prior to the first polymeric over-coat 20a and the second polymeric over-coat 20b as set forth in FIG. 6. The multiple layers of polymeric over-coat 20a, 20b, 20c and 20d achieve aesthetics provided in the embodiment shown in FIG. 6 including variants in gloss level, translucence, and colorization as explained hereinabove. However, in this embodiment, the applique 18 is applied via the adhesive 30 directly to the wheel substrate 12. The wheel substrate 12, in this embodiment may be machined to provide a “bright shiny” surface to provide an even different aesthetic to the multiple layers of polymeric over-coat 20a, 20b, 20c and 20d while these layers also provide enhanced durability to the wheel substrate 12 and the applique 18.

FIG. 8 shows a further embodiment where the applique 18 is adhered to the intermediate polymer coating 24. As in earlier embodiments, the intermediate polymeric coating 20 is applied to the base polymeric coating 22 that is applied to the substrate 12 of the wheel 10. The first polymeric over-coating 20a is applied over the applique 18 and the intermediate polymeric coating 24 and the second polymeric over-coating 20b is applied over the first polymeric over-coating 20a. As such, the aesthetic surrounding the applique 18 is modified by the interaction between the first polymeric over-coating 20a and the intermediate polymer coating 28 that may be pigmented with colored pigments or metallic flake to achieve unique reflective interaction with first and second polymeric over-coatings 20a, 20b.

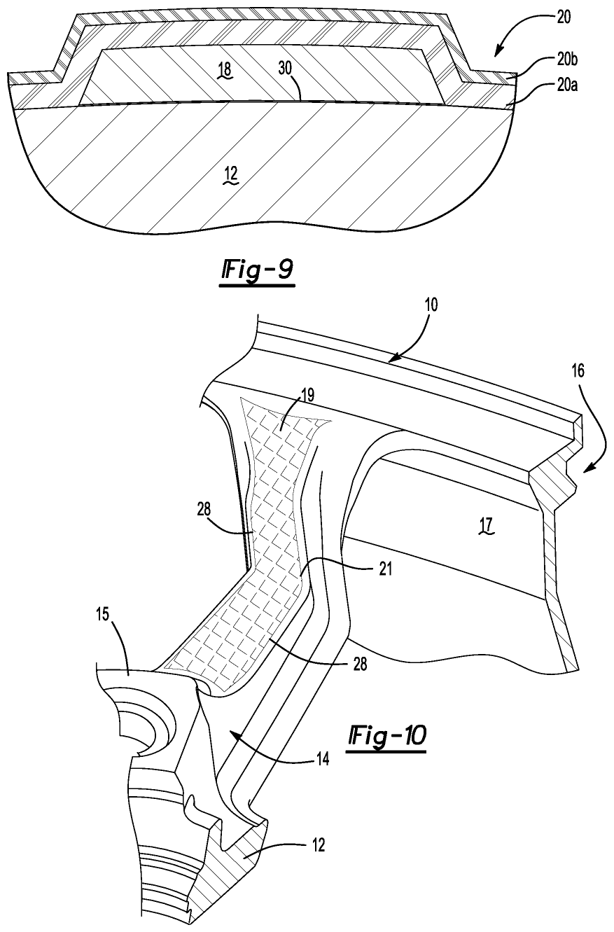

FIG. 9 shows a still further embodiment in which the applique 18 is applied via the adhesive 30 to the substrate 12 of the wheel over which the first polymeric over-coat 20a is applied followed by application of the second polymeric over-coat 20b that may include high, mid or low gloss level, and includes pigmentation, dye or other colorant while allowing at least some level of transparency. Therefore, additional alternative aesthetics of the applique 18 and of the surface of the substrate 12 are further modified.

It should be apparent to those of ordinary skill in the art after reading the disclosure set forth herein, that unique and distinguishing aesthetics are achievable through the applique 18 of the present invention and by modifying the sequence and types of polymeric coatings and PVD metallic layers. Applying polymeric coatings over the applique 18 to achieve a continuous and polymeric or substrate 12 of the wheel 10 provides not only unique opportunities for alternative aesthetics presenting, when desired, an appearance that the applique is part of the wheel substrate 12, but also provides uniform and improved durability to the wheel 10.

FIG. 10 shows an alternative applique 19 presenting a textured surface to generate depth for a unique aesthetic appearance without a need for costly machining or tooling. While shown adhered to the mating portion 21, the applique 19 can be placed on any wheel surface to achieve the unique aesthetic. Further, any type of the coating combinations shown in FIGS. 2 through 9 may be used to alter the appearance of the alternative applique 19.

Referring now to FIG. 13, a process flow diagram shows the steps of one embodiment of manufacturing the wheel of the present invention that incorporates the decorative applique 18. STEP 100, the wheel enters an applique 18 install station. STEP 200, the applique 18 is applied either to the wheel substrate 12 or previously applied polymer coatings 22, 28, or PVD coating as required of a desired wheel appearance. The applique 18 is applied either manually, for low volume production, or robotically, for high volume production. STEP 300, the wheel exits the applique install station after the applique 18 has been adhered to the wheel either mechanically or by way of adhesive as described above. It should also be understood that the wheel is transferred between stations on a moving assembly line. Alternatively, the stations are modular and various methods of transfer are employed.

Following exit from the applique install station, alternative processing may take place, depending upon the desired appearance of the wheel. In one embodiment, STEP 600, the wheel is transferred to an extra processing cell where the wheel is subject to milling, machining, turning, or the like to reshape the wheel configuration or expose the substrate 12 after the applique 18 has been adhered. In this step, the applique is located in the mating portion 21 of the spoke 14 beneath the upper surface 28 to avoid being damage during the milling or turning operation. It should be understood that while the present application discloses in detail locating the applique 18 on a spoke 14, the applique 18 could be located anywhere on the face portion 15 of the wheel, including but not limited to the central portion 15. Further, the applique 18 could also be located on the bead 17 defined by the rim portion 16. Following STEP 600, the wheel necessarily requires cleaning and application of a conversion coating, which is achieved in a pretreatment cell identified in STEP 700. Following the pretreatments cell, the wheel is transferred again to the clear polymeric over-coat cell identified as STEP 400 in FIG. 13.

In an alternative embodiment, following applique application performed in STEP 300, the wheel is immediately transferred to the clear polymer coating cell identified as STEP 400. In both embodiments, the clear polymeric over-coat 20, as explained above, may include liquid or powder compositions or be formulated for infrared or heated curing. If the clear polymer coating requires heat curing, the wheel is transferred to bake oven identified as STEP 500a. If the clear polymer coating requires infrared curing, the wheel is transferred to an infrared curing cell identified as STEP 500b. After curing, the wheel is inspected and packed for shipping at STEP 800. It should be understood that the assembly process is completely flexible and adapted to hand both heat curing wheels and infrared curing on the same assembly line by making use of various transfer conveyor technology. It should also be understood that the process steps could include a PVD metal application step in which the applique 18 is either adhered to the PVD metal, or the PVD metal coating is covered with a clear polymeric coating and the applique is adhered to the clear polymeric coating.

Obviously, many modifications and variations of the present invention are possible in light of the above teachings. The foregoing invention has been described in accordance with the relevant legal standards; thus, the description is merely exemplary than limiting in nature. Variations and modifications to the disclosed embodiment may become apparent to those skilled in the art and do come within the scope of this invention. Accordingly, the scope of a legal protection afforded this invention can only be determined by studying the following claims.

What is claimed is:

1. A method of decorating a vehicle wheel, comprising the steps of:
forming a vehicle wheel having an alloy substrate;
providing an applique including a decorative feature and adhering said applique to said vehicle wheel;
applying a first transparent polymer coating over said applique and said vehicle wheel thereby forming a continuous polymer surface extending over said applique and said vehicle wheel.

2. The method set forth in claim 1, wherein said step of applying a first transparent polymeric coating is further defined by presenting a same gloss level over said applique and said wheel.

3. The method set forth in claim 1, wherein said step of applying a first transparent polymeric coating is further defined by said transparent polymeric coating being tinted.

4. The method set forth in claim 1, further including a step of applying a primer polymeric coating over said alloy substrate prior to adhering said applique to said wheel thereby adhering the applique to said primer polymeric coating.

5. The method set forth in claim 4, further including a step of removing the primer polymeric coating from said alloy substrate of said wheel beneath said applique prior to adhering said applique to said wheel thereby adhering said applique to said alloy substrate.

6. The method set forth in claim 4, further including a step of applying an intermediate polymeric coating over said primer polymeric coating prior to adhering said applique to said wheel thereby adhering said applique to said intermediate polymeric coating.

7. The method set forth in claim 6, further including a step of applying a second transparent polymeric coating over said first polymeric coating.

8. The method set forth in claim 7, wherein said step of applying a second transparent polymeric coating over said first polymeric coating is further defined by coloring said second transparent polymeric coating.

9. The method set forth in claim 1, further including a step of applying a metallic layer over said primer polymeric coating prior to adhering said applique to said wheel.

10. The method set forth in claim 1, wherein said step of applying an applique to said wheel is further defined by applying a three dimensional applique to said wheel.

11. The method set forth in claim 1, further including a step of providing cooperable locating features on at least one of said wheel and said applique for locating said applique on said wheel.

12. The method set forth in claim 7, wherein said step applying a fourth polymeric coating is further defined by applying a fourth polymeric coating being at least one of tinted, pigmented, low gloss level, and mid gloss level.

13. A vehicle wheel, comprising:
a wheel defined by a wheel substrate including a face and a rim portion, said central portion defining a plurality of spokes extending radially outwardly between a central portion of said face and said rim portion;
said wheel defining a mating portion;
an applique affixed to said wheel at said mating portion;
a polymer over-coating being substantially transparent extending over said applique and said wheel substrate thereby defining a continuous polymer surface over said applique and said wheel substrate.

14. The vehicle wheel set forth in claim 13, wherein said polymer over-coating provides a same gloss level over said applique and said wheel substrate.

15. The vehicle wheel set forth in claim 13, wherein said polymer over-coating includes coloring.

16. The vehicle wheel set forth in claim 13, wherein said polymer over-coating includes a plurality of polymer layers.

17. The vehicle wheel set forth in claim 13, further including a primer polymer coating disposed being adhered to said wheel substrate beneath at least one of said applique and said polymer over-coating.

18. The vehicle wheel set forth in claim 17, further including an intermediate coating disposed between said primer polymer coating beneath at least one of said applique and said polymer over-coating.

19. The vehicle wheel set forth in claim 17, further including a metal layer disposed between said primer polymer layer and said at least one of said applique and said polymer over-coting.

20. The vehicle wheel set forth in claim 17, wherein said wheel substrate is visible through said polymer over-coat.

21. The vehicle wheel set forth in claim 13, wherein said applique is three dimensional.

22. The vehicle wheel set forth in claim 13, wherein said applique is two dimensional.
